(19) United States
(12) Patent Application Publication
(10) Pub. No.: US 2016/0034970 A1
(43) Pub. Date: Feb. 4, 2016

(54) USER-GENERATED QUICK RECOMMENDATIONS IN A MEDIA RECOMMENDATION SYSTEM

(71) Applicant: Luma, LLC, St. Louis Park, MN (US)

(72) Inventors: James Musil, Minneapolis, MN (US); Aaron Weber, Orono, MN (US); Colin Keeley, Minneapolis, MN (US); Robert Bodor, Plymouth, MN (US)

(21) Appl. No.: 14/879,475

(22) Filed: Oct. 9, 2015

Related U.S. Application Data
(63) Continuation-in-part of application No. 14/483,452, filed on Sep. 11, 2014.
Application No. 14/483,452 is a continuation-in-part of application No. 14/832,279, filed on Aug. 21, 2015.
Application No. 14/832,279 is a continuation-in-part of application No. 13/792,729, filed on Mar. 11, 2013, now abandoned.
Application No. 13/792,729 is a continuation-in-part of application No. 12/892,274, filed on Sep. 28, 2010, now Pat. No. 8,401,983.
Application No. 12/892,274 is a continuation-in-part of application No. 12/892,320, filed on Sep. 28, 2010, now Pat. No. 8,825,574.
Application No. 12/892,320 is a continuation-in-part of application No. 12/903,830, filed on Oct. 13, 2010.
(60) Provisional application No. 61/876,653, filed on Sep. 11, 2013.
(60) Provisional application No. 61/251,191, filed on Oct. 13, 2009.

(51) Int. Cl. G06Q 30/02; H04N 21/482; H04N 21/25; G06F 17/30; H04N 21/466

(52) U.S. Cl. CPC G06Q 30/0269; G06F 17/30029; G06F 17/3005; G06F 17/30867; H04N 21/4668; H04N 21/251; H04N 21/482

(57) ABSTRACT

A method of operating a recommendation system comprises receiving an indication that a first user has knowledge of a first media item, and receiving an indication that a second user has expressed interest in the first media item, wherein the first user and the second user are associated. The first user is prompted to recommend the first media item to the second user, based on the first user's knowledge of the media item and the second user's indication of interest in the media item.

### CROSS-REFERENCE TO RELATED APPLICATIONS

This application is a continuation-in-part of U.S. patent application Ser. No. 14/483,452, filed on Sep. 11, 2014, which claims the benefit of U.S. Provisional Application No. 61/876,653, filed on Sep. 11, 2013. This application is also a continuation-in-part of U.S. patent application Ser. No. 14/832,279, filed on Aug. 21, 2015, which is a continuation-in-part of U.S. patent application Ser. No. 13/792,729, filed on Mar. 11, 2013, which is a continuation-in-part of U.S. patent application Ser. No. 12/892,274, now U.S. Pat. No. 8,401,983, filed on Sep. 28, 2010. The present application is further continuation-in-part of U.S. patent application Ser. No. 12/892,320, now U.S. Pat. No. 8,825,574, filed on Sep. 28, 2010. This application is further continuation-in-part of U.S. patent application Ser. No. 12/903,830, filed on Oct. 13, 2010, and which claims the priority of U.S. Provisional Application No. 61/251,191, filed on Oct. 13, 2009. All of the U.S. priority applications are herein incorporated by reference.

### FIELD

The invention relates generally to media item recommendation, and more specifically to user-provided recommendations in a media recommendation system.

### BACKGROUND

The rapid growth of the Internet and the proliferation of inexpensive digital media devices have led to significant changes in the way media is bought and sold. Online vendors provide music, movies, and other media for sale on websites such as Amazon, for rent on websites such as Netflix, and available for person-to-person sale on websites such as EBay. The media is often distributed in a variety of formats, such as a movie available for purchase or rental on a DVD or Blu-Ray disc, for purchase and download, or for streaming delivery to a computer, media appliance, or mobile device.

Internet companies that provide media such as music, books, and movies derive profit from their sales, and it is in their best interest to sell customers multiple items or subscriptions to provide an ongoing stream of profits. Netflix, for example, provides a subscription service to customers enabling them to rent or stream movies, and profits as long as subscribers continue to find enough new movies to watch to remain a subscriber. Pandora provides streaming audio in a customized music station format based on a customer's music preferences, deriving profit from either subscriptions or from advertising placed in limited free services. Amazon derives the majority of its profits from sale of physical media, and increases its profit from providing a customer with media recommendations similar to items that a customer has already purchased.

Recommendations such as these are typically made by employing a recommendation engine to identify media that is similar to other media in which a customer has shown an interest, such as by purchasing, renting, or rating related media. Pandora, for example, uses an expert's characterization of a song using domain knowledge attributes such as structure, instrumentation, rhythm, and lyrical content to produce domain knowledge data for each song, and provides streaming songs matching identified customer preferences for one or more distinct customized stations based on its domain knowledge-based recommendation engine. Other media providers such as Netflix provide correlation-based recommendations, where user preferences for similar movies over a broad base of users and media are used to find preference correlation between the media and users in the database to recommend media correlated to other media a customer has liked.

Because the number of items purchased or the length of a subscription are related to the value customers receive in continuing to interact with a media provider, it is in the provider's best interest to provide media recommendations that are accurate and well-tailored to its customers, and that are usable in a variety of media use environments. But, the quality of media recommendations in many systems is related to the quality of the underlying media data for the candidate media items that may be recommended. It is therefore desirable to use high quality data regarding media and user preferences provide the best quality media recommendations.

### SUMMARY

One example embodiment of the invention comprises a method of operating a recommendation system. The system receives an indication that a first user has knowledge of a first media item, and an indication that a second user has expressed interest in the first media item. The first user and the second user are associated. The system prompts the first user to recommend the first media item to the second user, based on the first user's knowledge of the media item and the second user's indication of interest in the media item.

In a further example, the system receives input from the first user responsive to the prompting, and recommends the first media item to the second user based on the received input from the first user. In another more detailed example, the indication that the first user has knowledge of the first media item comprises at least one of a rating of the first media item, a review of the first media item, purchase of the first media item, or rental of the first media item. In another further example, the indication that the second user has expressed interest in the first media item comprises at least one of the second user viewing a description of the first media item, queuing the first media item, or previewing the first media item

In another example, a method of operating a recommendation system comprises receiving an indication that a first user has an interest in a first media item, and searching media item preferences for one or more friends of the first user for the one or more friends' preferences regarding the first media item. The system presents to the first user an indication of which of the one or more friends would enjoy watching the first media item with the first user.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows a media recommendation system enabling user-provided recommendations, consistent with an example embodiment of the invention.

FIG. 2 shows a web page of a media recommendation system enabling users to provide media recommendations, consistent with an example embodiment of the invention.

FIG. 3 shows a web page including media item privacy settings, consistent with an example embodiment of the invention.

FIG. 4 shows a web page summarizing user-attested recommendations made to a user, consistent with an example embodiment of the invention.

FIG. 5 is a flowchart of a method of user-provided media recommendations, consistent with an example embodiment of the invention.

FIG. 6 is a computerized media recommendation system comprising user-based media recommendations, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

Recommendation of media such as books, movies, or music that a customer is likely to enjoy can improve the sales of online merchants such as Amazon, improve the subscription rate and customer duration of rental services such as Netflix, and help the utilization rate of advertising-driven services such as Pandora. Although revenue is derived from providing media in different ways in each of these examples, they all benefit from providing good quality recommendations to customers regarding potential media purchases, rentals, or other media use. Similarly, knowledge of a user's preferences and interests can help target advertising that is relevant to a particular user, such as advertising horror movies only to those who have shown an interest in honor films, targeting country music advertising toward those who prefer country to rap or pop music, and presenting advertising for a new book to those who have shown a preference for similar books.

Media recommendations such as these are typically made by employing a recommendation engine to identify media that is similar to other media in which a customer has shown an interest, such as by purchasing, renting, or rating other similar media. Some websites, such as Netflix, ask a user to rate dozens of movies upon enrollment so that the recommendation engine can provide meaningful results. Other websites such as Amazon rely more upon a customer's purchase history and items viewed during shopping. Pandora differs from these approaches in that a user can rate relatively few pieces of media, and is provided a broad range of potentially similar media based on domain knowledge of the selected media items.

Because the number of items purchased or the length of a subscription are related to the value a customer receives in interacting with a media provider, it is in the provider's best interest to provide media recommendations that are accurate and well-suited to its customers. Poor recommendations may result in a user abandoning a service or merchant for another, while good recommendations will likely result in additional sales and profit. It is therefore desirable to accurately characterize and predict a user's media preferences to provide the best quality media recommendations possible.

Making accurate recommendations relies in part in having accurate data regarding characteristics of media that may be recommended, so that information regarding a user's preferences can be used to accurately search through media to select items to recommend. For example, a system such as Pandora that relies on domain knowledge of songs to recommend other songs relies on accurate expert characterization of various attributes of each song in its library to enable songs to be found and recommended based on the characterized attributes. Other recommendation systems rely more heavily on correlation, such as determining what other items a user who likes a certain movie is most likely to like by mining a database of user ratings or preference information.

But, using correlation in media preference is an imperfect way of establishing similarity between items, as users may like unrelated items or otherwise rate different items similarly. For example, if a high percentage of users who like the movie The Notebook also like the movie Titanic, most people will agree that these movies have similar characteristics and appeal. If a high percentage of users who like the movie The Notebook also like the television show Mythbusters, the connection is less clear and there may be some question as to whether the correlation is due to an obscure or infrequently rated item having a chance correlation with other media. Similarly, domain characteristics may be somewhat subjective and may not accurately predict other media a user may like. For example, a user may like one particular country song, but have little or no interest in songs having similar domain profiles.

Some embodiments of the invention therefore employ user-based recommendations, such as prompting a user who has knowledge of a certain media item to make a recommendation regarding the media item to a friend or other associated user. In a further example, the user is prompted to recommend only items in which the friend has shown some interest, such as by viewing a description of the first media item, by queuing the first media item, or by previewing the first media item. In other embodiments, crowdsourced pair-based recommendations are similarly made for other products or services, such as restaurants, consumer goods, and the like.

In a more detailed example, a media recommendation system prompts a first user to recommend a movie to a second user, such as by presenting the user with a screen on a web page or a smart phone or tablet application that prompts the user to recommend the movie. The media item in a further example is a media item that the first user has knowledge of, and in which the second user has expressed interest in some way. Indication that the first user has knowledge of the media item includes the first user rating the media item, reviewing the media item, purchasing the media item, renting the media item, making a social media or other posting about the media item, or otherwise indicating that the first user has knowledge about the media item. Second user expression of interest in the media item includes viewing a description of the media item, queuing the first media item for later use, previewing the media item, or other expressions of interest in the media item.

In another example, the first user is presented a list of two or more media items that the first user has knowledge of and in which the second user has expressed interest, and is asked to pick which of the media items the first user would recommend to the second user. In a further example, the first user may elect to select none of the media items and make no recommendation, or to choose from a different group of candidate media items.

The second user in some examples receives recommendations from various first users through a recommendation page, through a sidebar on another media recommendation page, or through another suitable mechanism. In a further example, the media recommendation system presents the second user with a list of media items that other users have recommended, such as a list ordered by the number of recommendations received from other users who are friends of the second user.

In some examples, the second user may shield movies from being presented to the first user for recommendation by using privacy settings controlling what media item information is shared and how it is shared with other users.

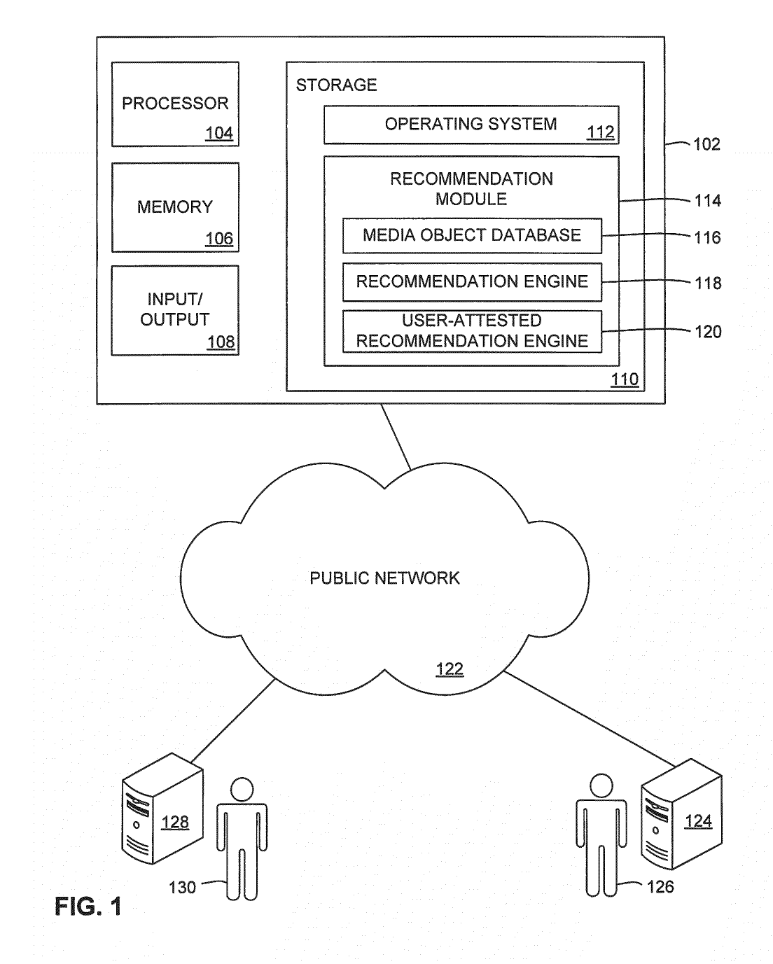

FIG. 1 shows a media recommendation system enabling user-provided recommendations, consistent with an example embodiment of the invention. Here, media recommendation system 102 comprises a processor 104, memory 106, input/output elements 108, and storage 110. Storage 110 includes an operating system 112, and a recommendation module 114 that is operable to provide media item recommendations to a user, including user-provided recommendations. The recommendation module 114 further comprises a media object database 116 operable to store media object information and user preference information for various media objects. A recommendation engine 118 is operable to use the stored media preference information for various recommendation system users to provide media recommendations. User-attested recommendation engine 120 is operable to prompt users for media item recommendations for other users, such as recommending items the user has knowledge of to one or more friends who are likely to enjoy the media item, and to provide such recommendations to the user's friends.

The media recommendation system 102 is connected to a public network 122, such as the Internet. Public network 122 serves to connect the media recommendation system 102 to remote computer systems, including user computer 124 (associated with user 126). In this example, friend user's computer 126 is further connected to media recommendation system 102, and is associated with friend user 130 who is a friend of user 126.

In operation, the media recommendation system's processor 104 executes program instructions loaded from storage 110 into memory 106, such as operating system 112 and recommendation module 114. The recommendation module includes software executable to provide media recommendations to users such as user 130, using recommendation engine 118 and media object database 116.

The media item recommendations generated by recommendation engine 118 are based in some examples upon media preference information for a user, such as information regarding a user's media purchases, ratings, and viewings, across multiple websites and services. To produce the most accurate media recommendations, media recommendation system 102 gathers such media preference information to populate a media object database 116 containing each user's preferences. This information can then be used to generate recommendations for other media items, such as by using correlation-based recommendations, domain knowledge-based recommendations, or recommendations made using a combination of correlation-based and domain knowledge-based information.

In this example, the user-attested recommendation engine 120 is operable to provide recommendations to users such as user 126 and friend user 130, based at least in part on user approval or attestation of the recommendation. Such a user-provided recommendation may be more meaningful to some users in that it carries the weight of a recommendation from a friend, rather than being entirely machine logic-based.

In a more detailed example, the user-attested recommendation engine 120 finds one or more media items that the user 126 is familiar with, such as movies that the user 126 has reviewed, rented, or bought, and in which friend user 130 has shown an interest, such as by previewing, queuing, or otherwise interacting with the media item. The media items selected for recommendation are in a further example media items that friend user 130 is likely to enjoy, based on friend user 130's media preference history and information regarding the candidate media items such as correlation or domain-knowledge information in media object database 116. A recommendation engine 118 in a further example predicts the friend user will like the recommended media item or items based on the friend user's known media preferences.

The user-attested recommendation engine presents the selected media item or items to user 126, along with a prompt to recommend one of the one or more items to friend user 130. The user 126 may select an item that user 126 most believes friend user 130 will enjoy, or may decline to make any recommendation. The user-attested recommendation engine receives the recommendation, and provides the recommendation to the friend user 130 when the friend user 130 logs on to the media recommendation system 102.

In a further example, media recommendations from various friends are compiled and presented to the friend user 130, such as in an ordered list. In one such example, the media items are presented with the most-recommended item first, along with an indication of who recommended each of the media items.

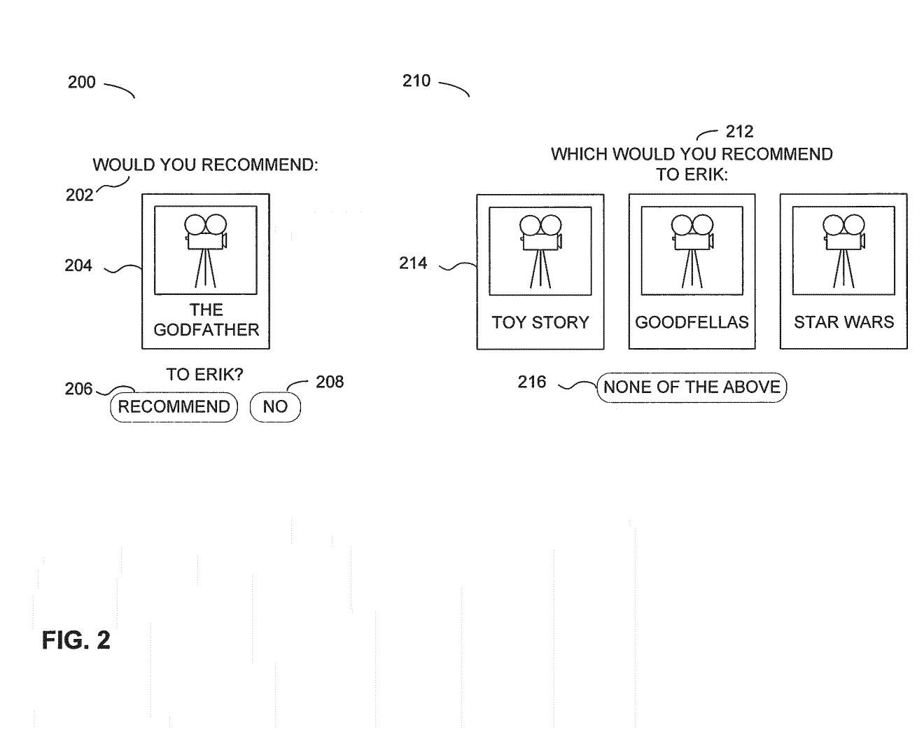

FIG. 2 shows a web page of a media recommendation system enabling users to provide media recommendations, consistent with an example embodiment of the invention. The example web page shown may be presented to a such as user 126 of FIG. 1 using user 126's computer 124 via a network connection to media server 102, which executes user-attested recommendation engine 120.

Here, a screen image shown generally at 200 includes a query as shown at 202 regarding a first media item, identified at 204. The query shown at 202 in this example is asking the user “Would you Recommend” the movie identified at 204, “The Godfather,” to friend Erik. The user has the option of selecting button 206 to recommend the movie, thereby sending what is called in some examples a quick recommendation or a user-provided recommendation to user Erik.

The user in this example may also select “No” as reflected at 208, which in various embodiments will result in display of another candidate media item at 204, and removal of the media item that was not recommended from future consideration for user-provided recommendation. The screen image shown generally at 200 is in some embodiments shown on a screen having primarily other content, such as being displayed as part of a sidebar. In other embodiments, a screen such as is shown here can be selected via menu options or otherwise provided as a screen where the information shown is the primary content for the screen.

In another example shown generally at 210, the user is prompted to select “Which Would You Recommend to Erik” at 212. The screen image shown at 210 includes three media items as shown at 214, including the movies “Toy Story,” “Goodfellas,” and “Star Wars.” The user selects a movie for recommendation by clicking on the icon representation of the chosen movie as shown at 214, or selects “None of the Above” at 216. In some embodiments, selecting “None of the Above” results in presentation of another set of media from which to select a recommendation, while in other embodiments no additional media is presented if a user selects “None of the Above.”

Media selected for presentation in the screen images shown generally at 200 and 210 is selected based on an indication that the recommending user has knowledge of the media item, and on an indication that the friend user to whom the media is recommended has expressed interest in the media item. For example, the media items shown in FIG. 2 may be movies that the recommending user has viewed, queued, reviewed, rented, bought, or rated, as reflected in the media object database 116 of media recommendation server 102. The movies in a further example are also desirably movies in which the friend user to whom the movies are recommended has expressed an interest, such as by viewing a description, previewing, or queuing the media item.

Presenting items for recommendation to a first user for recommendation to a second user based on the second user's interaction with the media item may reveal preference information regarding the media item to the first user that the second user may wish to keep private. For example, if the user-attested recommendation engine 120 presents a movie “Toy Story” for possible recommendation to Erik, as reflected at 210, it has implicitly told the first user that Erik has expressed an interest in the movie, such as by queuing or previewing the movie. Some embodiments therefore provide privacy settings, allowing a user to control how such information is shared with other users.

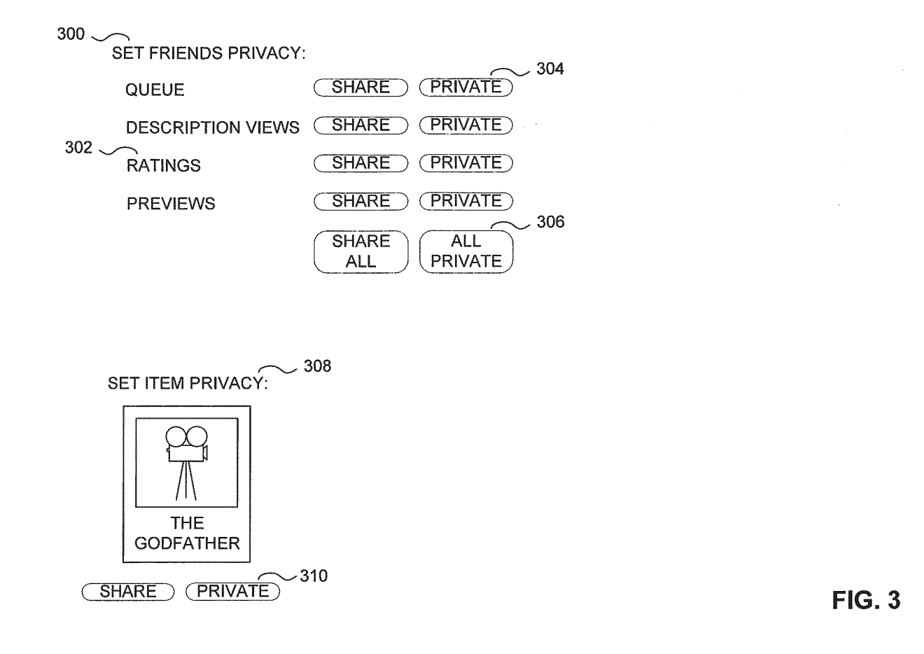

FIG. 3 shows a web page including media item privacy settings, consistent with an example embodiment of the invention. Here, a “Set Friends Privacy” screen is shown generally at 300, enabling a user to set various user actions or data to be shared or private. For example, a user may elect to make his queue private by clicking the “Private” button associated with the “Queue” item as shown at 304, but may elect to share ratings by clicking the “Share” button associated with ratings as shown below. A user may similarly share all data and actions presented by clicking “Share All,” or may make all items private by clicking “All Private” as shown at 306. Because media items selected for presentation for user-attested recommendations are chosen based at least in part on the user to whom the media is recommended having expressed an interest in the media items, such as through previews, description views, queue adds, and the like, setting this information to private will prevent the user-attested recommendation engine 120 from using it in choosing candidate media items for recommendation.

In another example, item-by-item privacy may be set, as shown at 308. Here, the movie “The Godfather” has been selected for privacy setting modification, and the user selects whether to share or make private the user's interaction with the movie by selecting the appropriate button as shown at 310. In an alternate example, the user is able to select sharing or making private various interactions with the media item, such as is shown above at 302.

Privacy settings such as these allow a user to control how information regarding their interaction with media items is used to present other users such as friends with prompted recommendation screens such as those shown in FIG. 2, potentially revealing the user's interaction with the media item to other users.

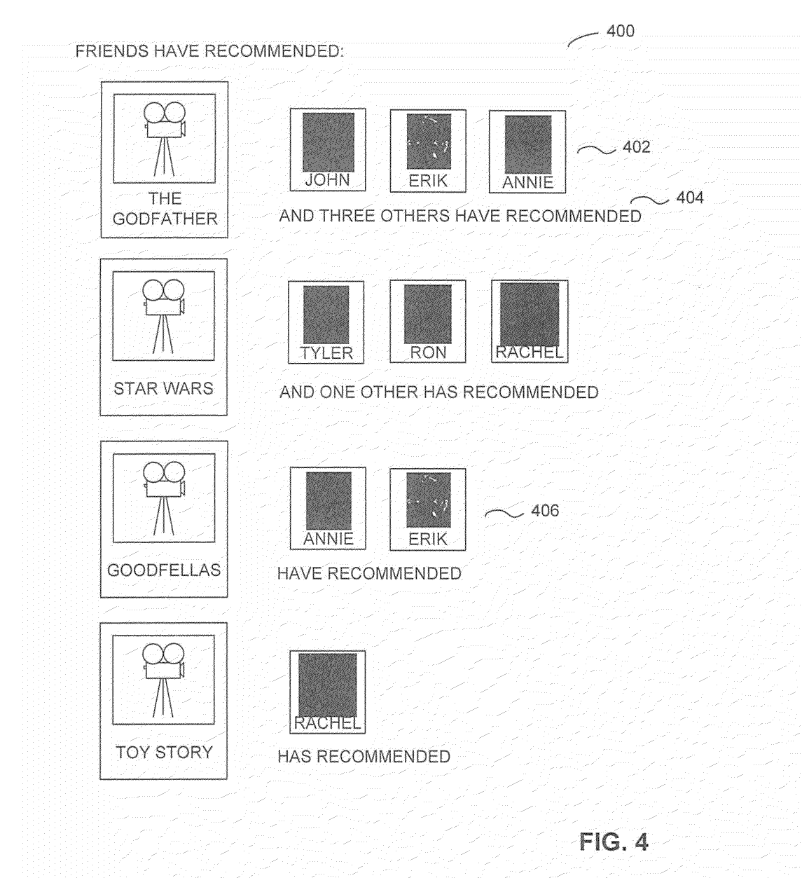

FIG. 4 shows a web page summarizing user-attested recommendations made to a user, consistent with an example embodiment of the invention. Here, a web page, smart phone or tablet screen, or other such presentation shown generally at 400 includes an ordered list of movies that a user's friends have recommended to the user. First listed is the movie “The Godfather,” ordered first because six people have recommending the movie. In this example, at least some friends who have recommended are explicitly identified on the screen, as shown at 402, while the remaining people recommending the movie can be viewed by clicking “and three others have recommended” as shown at 404. In various examples, the three people shown at 402 are the three friend with whom the user has interacted the most, are the three most recent to recommend the movie, or are selected through other such methods. The next movie in the recommendation list, “Star Wars,” is recommended by four people, one fewer than “The Godfather” but two more than recommended “Godfellas.” Because three or fewer people recommended the third movie in the list, “Goodfellas,” all people who have recommended the movie are shown at 406.

Presenting the movies in ranked order as shown at 400 enables the user to see the most-recommended movies first, focusing attention on the most-recommended movies at the top of the list. Displaying the number of recommendations for each movie similarly enables a user to gauge which movies are most popular among the user's friends, and which movies the user's friends most often thin the user would enjoy seeing. Showing who has recommended which movie allows the user to consider not only the number of recommendations, but how much the user trusts recommendations from various users in determining which of the recommended movies to watch.

In a further embodiment, the media use record of one or more friends are tracked and presented in a format such as that of FIG. 4, such as by showing the number of friends who have watched various media items. In a further example, the media items are filtered to include media items the user has not watched, or are presented along with an indication of whether the user has watched each of the media items. The user may choose alternate views for such data, such as viewing a timeline view of user-attested recommendations or a timeline view of friends' media viewing, reviews, and the like.

Providing a user-attested or user-generated recommendation system such as is described in the examples herein provides a user with an additional mechanism for finding new media, such as movies, to watch. It also adds a social aspect to media recommendation and use, connecting users to their friends through shared interests and topics for conversation. Enhancements such as these not only make a media recommendation system more enjoyable, but add to the likelihood that a user will use the media recommendation system, thereby increasing the frequency and duration of media recommendation system use and associated media use.

In another example, one or more media items or friends that have recommended a media item are associated with a “Discuss” button, or other suitable mechanism for initiating a discussion regarding the media item between two or more friends. For example, the user of FIG. 4 may wish to discuss “Toy Story” with Rachel, such as to determine why she recommended the movie. Similarly, the user may wish to discuss with Annie and Erik after viewing “Goodfellas” what the user did or did not like about the movie. Incorporating a social media aspect such as this into the media recommendation system can enhance the user experience by providing a mechanism to initiate communication and encourage discussion with friends, and by making media selection and recommendation more interactive.

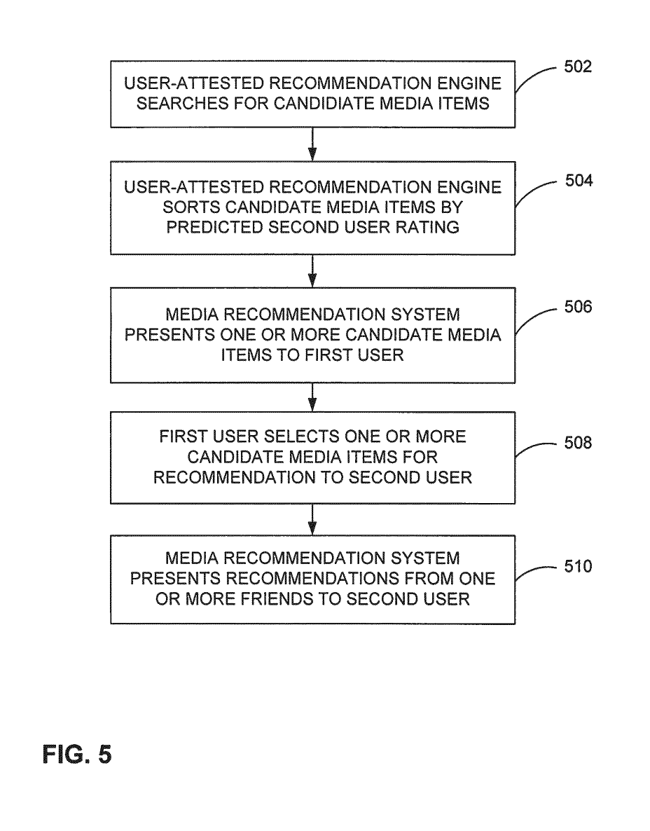

FIG. 5 shows an example method of operating a user-generated media recommendation system, consistent with an example embodiment of the invention. At 502, a media recommendation system's user-attested recommendation engine searches a media object database for one or more candidate media items of which the first user has knowledge, and in which the second user has expressed interest. First user knowledge is determined in various examples through the first user rating the media item, reviewing the first media item, purchasing the first media item, or renting the first media item. Expression of the second user's interest in the media item is determined in various embodiments by the second user viewing a description of the media item, queuing the media item, or previewing the first media item. In an alternate example, no expression of second user interest is needed to select a candidate media item.

The found candidate media items are sorted at 504, based on the predicted second user's rating of each media item. For example, the second user's predicted rating of the candidate media items is performed via correlation-based analysis, domain-based analysis, or a combination of correlation-based and domain-based analysis in various embodiments. The candidate media items are then ordered in order of the second user's predicted rating, such that the items with the highest predicted ratings are presented to the first user to consider recommending to the second user.

The media recommendation system presents one or more top candidate media items to the first user at 506, such as presenting a single media item for consideration or a group of media items from which to pick a media item to recommend. The first user selects one or more of the presented candidate media items for recommendation to the second user at 508, and may in a further embodiment elect not to recommend one of the candidate media items to the second user, or may elect to see another group of candidate media items from which to select an item for recommendation.

The media recommendation system presents the recommendations from one or more friends, such as the first user, to the second user at 510. Presentation of the one or more user-attested or user-provided recommendations comprises in various examples presentation of the recommendation in a sidebar, on a social media page, in a recommendations page, or through other such methods to the second user.

The server providing user-attested recommendations and the media recommendation server in the examples presented here comprise parts of the same server, but in other embodiments will be separate servers, distributed servers, or otherwise configured differently to provide the various functions described herein. For example, the user-provided recommendations in some embodiments is provided via a social media service such as Facebook or the like, rather than being presented through the media recommendation server 102.

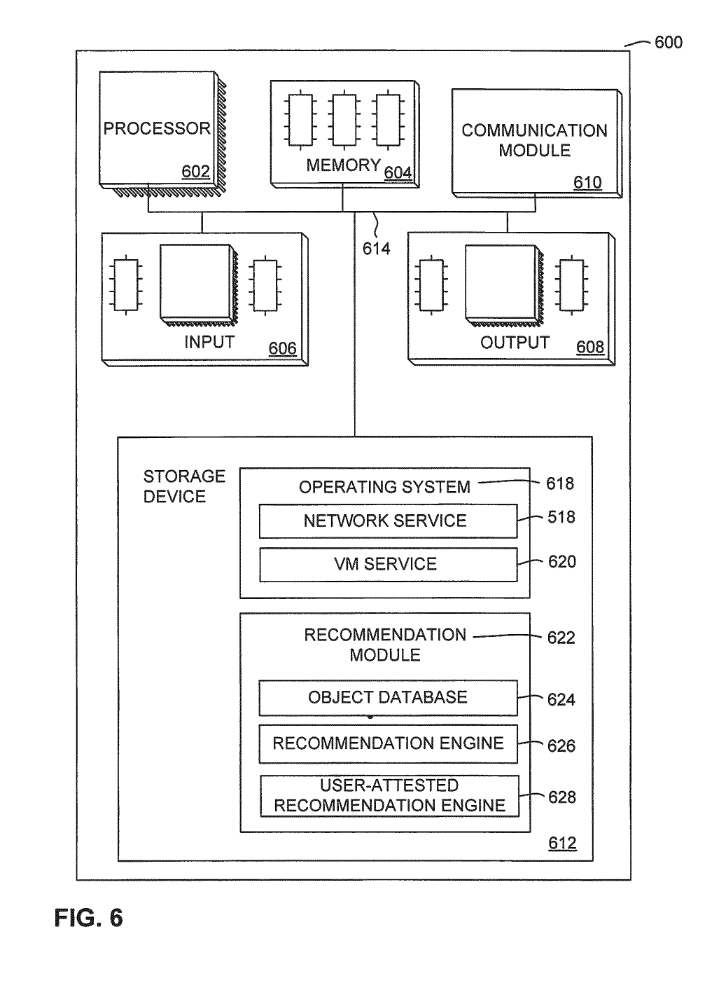

FIG. 6 is a computerized media recommendation system comprising a user-attested recommendation engine, consistent with an example embodiment of the invention. FIG. 6 illustrates only one particular example of computing device 600, and other computing devices 600 may be used in other embodiments. Although computing device 600 is shown as a standalone computing device, computing device 600 may be any component or system that includes one or more processors or another suitable computing environment for executing software instructions in other examples, and need not include all of the elements shown here.

As shown in the specific example of FIG. 6, computing device 600 includes one or more processors 602, memory 604, one or more input devices 606, one or more output devices 608, one or more communication modules 610, and one or more storage devices 612. Computing device 600, in one example, further includes an operating system 616 executable by computing device 600. The operating system includes in various examples services such as a network service 618 and a virtual machine service 620 such as a virtual server. One or more applications, such as recommendation module 622 are also stored on storage device 612, and are executable by computing device 600. Each of components 602, 604, 606, 608, 610, and 612 may be interconnected (physically, communicatively, and/or operatively) for inter-component communications, such as via one or more communications channels 614. In some examples, communication channels 614 include a system bus, network connection, inter-processor communication network, or any other channel for communicating data. Applications such as recommendation module 622 and operating system 616 may also communicate information with one another as well as with other components in computing device 600.

Processors 602, in one example, are configured to implement functionality and/or process instructions for execution within computing device 600. For example, processors 602 may be capable of processing instructions stored in storage device 612 or memory 604. Examples of processors 602 include any one or more of a microprocessor, a controller, a digital signal processor (DSP), an application specific integrated circuit (ASIC), a field-programmable gate array (FPGA), or similar discrete or integrated logic circuitry.

One or more storage devices 612 may be configured to store information within computing device 600 during operation. Storage device 612, in some examples, is known as a computer-readable storage medium. In some examples, storage device 612 comprises temporary memory, meaning that a primary purpose of storage device 612 is not long-term storage. Storage device 612 in some examples is a volatile memory, meaning that storage device 612 does not maintain stored contents when computing device 600 is turned off. In other examples, data is loaded from storage device 612 into memory 604 during operation. Examples of volatile memories include random access memories (RAM), dynamic random access memories (DRAM), static random access memories (SRAM), and other forms of volatile memories known in the art. In some examples, storage device 612 is used to store program instructions for execution by processors 602. Storage device 612 and memory 604, in various examples, are used by software or applications running on computing device 600 such as recommendation module 622 to temporarily store information during program execution.

Storage device 612, in some examples, includes one or more computer-readable storage media that may be configured to store larger amounts of information than volatile memory. Storage device 612 may further be configured for long-term storage of information. In some examples, storage devices 612 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 600, in some examples, also includes one or more communication modules 610. Computing device 600 in one example uses communication module 610 to communicate with external devices via one or more networks, such as one or more wireless networks. Communication module 610 may be a network interface card, such as an Ethernet card, an optical transceiver, a radio frequency transceiver, or any other type of device that can send and/or receive information. Other examples of such network interfaces include Bluetooth, 3G or 4G, WiFi radios, and Near-Field Communications (NFC), and Universal Serial Bus (USB). In some examples, computing device 600 uses communication module 610 to wirelessly communicate with an external device such as via public network 122 of FIG. 1.

Computing device 600 also includes in one example one or more input devices 606. Input device 606, in some examples, is configured to receive input from a user through tactile, audio, or video input. Examples of input device 606 include a touchscreen display, a mouse, a keyboard, a voice responsive system, video camera, microphone or any other type of device for detecting input from a user.

One or more output devices 608 may also be included in computing device 600. Output device 608, in some examples, is configured to provide output to a user using tactile, audio, or video stimuli. Output device 608, in one example, includes a display, a sound card, a video graphics adapter card, or any other type of device for converting a signal into an appropriate form understandable to humans or machines. Additional examples of output device 608 include a speaker, a light-emitting diode (LED) display, a liquid crystal display (LCD), or any other type of device that can generate output to a user.

Computing device 600 may include operating system 616. Operating system 616, in some examples, controls the operation of components of computing device 600, and provides an interface from various applications such as recommendation module 622 to components of computing device 600. For example, operating system 616, in one example, facilitates the communication of various applications such as recommendation module 622 with processors 602, communication unit 610, storage device 612, input device 606, and output device 608. Applications such as recommendation module 622 may include program instructions and/or data that are executable by computing device 600. As one example, recommendation module 622 and its object database 624, recommendation engine 626, and user-attested recommendation engine 628 may include instructions that cause computing device 600 to perform one or more of the operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of operating a recommendation system, comprising:
receiving an indication that a first user has knowledge of a first media item;
receiving an indication that a second user has expressed interest in the first media item, wherein the first user and the second user are associated; and
prompting the first user to recommend the first media item to the second user, based on the first user's knowledge of the media item and the second user's indication of interest in the media item.

2. The method of operating a recommendation system of claim 1, further comprising receiving input from the first user responsive to the prompting, and recommending the first media item to the second user based on the received input from the first user.

3. The method of operating a recommendation system of claim 1, wherein the indication that the first user has knowledge of the first media item comprises at least one of a rating of the first media item, a review of the first media item, purchase of the first media item, or rental of the first media item.

4. The method of operating a recommendation system of claim 1, wherein the indication that the second user has expressed interest in the first media item comprises at least one of the second user viewing a description of the first media item, the second user queuing the first media item, the second user previewing the first media item, or a recommendation engine predicting the second user will like the first media item based on the second user's known media preferences.

5. The method of operating a recommendation system of claim 1, wherein prompting the first user to recommend the first media item to the second user comprises presenting the first user with two or more media items of which the first user has knowledge of and in which the second user has expressed interest, and prompting the first user to select which of the two or more media items the first user recommends to the second user.

6. The method of operating a recommendation system of claim 5, further comprising receiving a request from the second user to send a request for a recommendation from among the two or more media items to at least the first user.

7. The method of operating a recommendation system of claim 1, further comprising providing user-selectable media item privacy to the second user for one or more of the second user's media items, operable when privacy is selected for a private media item of the second user's media items to prevent the private media item from being presented to other users for recommendation.

8. The method of operating a recommendation system of claim 7, the user-selectable media item privacy selectable for one or more of the second user's queue, media item description views, or selected media items.

9. The method of operating a recommendation system of claim 7, the user-selectable media item privacy further operable when selected to prevent the private media item from being presented to users who are not friends of the second user.

10. The method of operating a recommendation system of claim 1, further comprising tracking recommendations for one or more media items for the second user from other users, and presenting an ordered list of media items based on number of recommendations from other users per media item.

11. The method of operating a recommendation system of claim 1, further comprising indicating to the first user the second user as a user to whom first user should recommend the first media item.

12. The method of operating a recommendation system of claim 1, further comprising tracking a successful recommendation rate for first user, and using the successful recommendation rate to adjust recommendations from first user presented to at least the second user.

13. The method of operating a recommendation system of claim 1, further comprising indicating to the second user one or more additional media items viewed or rated by one or more friends.

14. A method of operating a recommendation system, comprising:
receiving an indication that a first user has an interest in a first media item;
searching media item preferences for one or more friends of the first user for the one or more friends' preferences regarding the first media item; and
presenting to the first user an indication of which of the one or more friends would enjoy watching the first media item with the first user.

15. The method of operating a recommendation system of claim 14, further comprising receiving a request from the first user for an indication of one or more friends with whom the first user should watch the media item.

16. The method of operating a recommendation system of claim 14, wherein receiving an indication that the first user has an interest in the first media item comprises the first viewing a detailed description of the media item, the first user placing the first media item in a queue, or the first user previewing the first media item.

17. A media recommendation system, comprising:
a processor; and
a media recommendation module comprising instructions executable on the processor, the instructions operable when executed to:
receive an indication that a first user has knowledge of a first media item;
receive an indication that a second user has expressed interest in the first media item, wherein the first user and the second user are associated; and
prompt the first user to recommend the first media item to the second user, based on the first user's knowledge of the media item and the second user's indication of interest in the media item.

18. The media recommendation system of claim 17, the media recommendation module further operable to receive input from the first user responsive to the prompting, and recommend the first media item to the second user based on the received input from the first user.

19. The media recommendation system of claim 17, wherein the indication that the first user has knowledge of the first media item comprises at least one of a rating of the first media item, a review of the first media item, purchase of the first media item, or rental of the first media item.

20. The media recommendation system of claim 17, wherein the indication that the second user has expressed interest in the first media item comprises at least one of the second user viewing a description of the first media item, the second user queuing the first media item, the second user previewing the first media item, or a recommendation engine predicting the second user will like the first media item based on the second user's known media preferences.
